(19) United States
(12) Patent Application Publication
(10) Pub. No.: US 2007/0219873 A1
(43) Pub. Date: Sep. 20, 2007

(54) Internet procurement method with user manipulated fields and distribution form for use therewith

(75) Inventor: Kenneth Alan Fischburg, Norwich, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Consumers Interstate Corporation, Norwich, CT (US)

(21) Appl. No.: 11/376,027

(22) Filed: Mar. 14, 2006

(51) Int. Cl. G06Q 30/00

(52) U.S. Cl. 705/26

(57) ABSTRACT

In a method for procuring goods, the need for particular goods and the procurement habits of a customer are determined. A web site is hosted and is operative with a software-based program and a content database. Data indicative of the customer's needs for particular goods is input into content database. A custom electronic order form is created using the program and the data stored in the content database, the order form being unique to the customer. The customer accesses the custom electronic order form via a web page on the website and places an order for goods by filling in the custom electronic order form. The order is processed and the goods shipped.

### CROSS REFERENCE TO RELATED APPLICATIONS

This application is entitled to the benefit of and incorporates by reference essential subject matter disclosed in U.S. patent application Ser. No. 09/656,330 filed on Sep. 6, 2000, and issued as U.S. Pat. No. 6,895,389, dated May 17, 2005.

### TECHNICAL FIELD

The present invention relates generally to a web-based procurement method and forms for use therewith. More particularly, the present invention relates to a method of procuring goods and/or services via the Internet in which defined fields can be manipulated to facilitate the procurement of goods and/or services and to an order form that facilitates the use of the method.

### BACKGROUND OF THE INVENTION

Corporations and other organizations generally employ purchasing agents to procure supplies, such as paper products, janitorial products, and the like, as well as goods for resale to the public or other companies. Often these supplies or goods are procured from several different vendors and by different purchasing agents. For example, an organization having facilities in different locations may have a purchasing agent in each locale buying products from different vendors and possibly at different prices. Particularly, when the same products are purchased by different agents from different sources, a lack of effective communication can result in the payment of disparate amounts for the same item as well as the overstocking or understocking of certain items. Furthermore, volume discounts may be lost if the different purchasing agents do not realize that different agents are each purchasing the same products for the same organization.

In general, to purchase or order supplies or goods, the purchasing agent manually or electronically utilizes an order form. The manual use of paper forms can be time consuming and subject to loss, misfiling, or lag times that causes undesirable delays in the delivery of supplies or goods. The electronic use of forms (as well as the use of paper forms) can be limited to ordering goods and supplies listed without regard to changes in their availability. Additionally, typical electronic ordering systems rely on the use of predefined parameters that limit the ordering of the goods or supplies in a particular manner. Often the manners in which the goods or supplies can be ordered is not the most effective manner, particularly when several agents need to order several types of goods or supplies from several vendors for distribution to several different locations within (or outside of) an organization.

Another problem with prior art electronic methods of procuring goods is that the goods are shipped in packages that must be centrally received and unpacked so that specific items can be directed to different destinations that are often remotely located from one another. In cases in which the packages received at a central receiving station are pallets comprising several separate items, an inordinate number of items may have to be distributed and tracked. Once unpacked and directed to the appropriate destinations, a sub-receiving process is often necessitated, which typically results in the generation of multiple copies of paperwork that must be distributed, filed, and stored. Often such paperwork is not properly filed or maintained making tracking of goods and subsequent record keeping difficult or impossible.

Based on the foregoing, it is a general object of the present invention to provide an electronic method of procuring goods and/or supplies that is capable of being customized to accommodate the inefficiencies inherent in the prior art methods of electronically procuring goods. It is also a general object of the present invention to provide an effective means of tracking received goods and/or supplies through distribution channels within an organization.

### SUMMARY OF THE INVENTION

In one aspect, the present invention is directed to a method of ordering goods over an electronic network in a processor-based system. The processor-based system has a memory with an executable computer program stored therein. The method comprises the steps of identifying a need for particular goods by determining product requirements; accessing a web page of the electronic network; displaying the web page to a user; allowing the user to customize a web-based order form unique to that user based on needs identified; inputting data indicative of the goods into a content database via the custom electronic order form; hosting a web site operative with the computer program and the content database; processing the data input to place an order for the goods; and receiving the goods. The web site from which a user can access their custom electronic order form, which is typically located at a URL address on the Internet, is accessible via a PC or other communications apparatus having internet access capabilities.

The present invention also resides in a web-based order form whereby different user defined fields, such as, but not limited to general ledger fields can be customized to a particular user's preferences. In addition to general ledger fields, job specific fields can also be specified. These features will allow a user to generate financial reports that can be sorted to generate user customized reports. In addition, these reports can be accessed from anywhere that a user can access the internet. Accordingly, users can outsource their data collection and reporting.

The above-described user-specified fields can also be customized to allow a user to assign codes for particular facilities, departments, or individuals. In this manner, expenses can be closely tracked. These fields can be coded for single use, use for a specified period of time, or they can be permanently coded.

The present invention resides in still another aspect in the use of electronic signatures for populating the database where appropriate with proofs-of-delivery and receipt. For example, where a quantity of goods is delivered, there may be several invoices associated therewith, each requiring a signature from the person receiving the goods. This can be cumbersome, and sometimes signatures are missed or are accomplished in such haste that they are illegible. The present invention contemplates using an electronic signature whereby the receiver signs an electronic tablet that saves the signature, converts it to legible text and may even send the signature to the appropriate recipient via e-mail or populates the database with the signature by uploading it thereto. In lieu of signatures, a tablet or other electronic device that employs biometric recognition can be used. For example, fingerprint or retinal scanners can be employed to identify the receiver and provide an indication that the goods have in fact been received.

In another aspect, the present invention includes a form for the tracking and verification of receipt of goods by a supplier of goods. In one exemplary embodiment, the form comprises a first part left by the supplier with a receiving agent to which the goods are delivered, a second part retained by the supplier and a third part sent as an invoice for payment. Each of the three parts is pre-signed by the receiving agent. The form can be paper or electronically generated and signed, or electronically generated and printed on location using a handheld tablet or other handheld device having print capabilities.

In still another aspect of the present invention, using any of the above-described methods, a “Summary Invoice” can be generated, for example, once per month—however, the present invention is not limited in this regard—and can be accessed in one or more different ways. For example, the summary invoice can be accessed online, via e-mail or regular mail. The summary invoice can include all of the invoiced orders for a particular time period. A user will also be able to view the signatures of the person(s) who signed as having received the orders. These signatures may be shown as original and/or text converted from the original signature.

One advantage of the present invention is that the above-described method is web-based. By being web-based, the methods defined herein can be initiated from any point at which web access can be obtained. Accordingly, a purchasing agent (or agent with comparable duties) can order, verify, track, and perform any other necessary functions from virtually anywhere a satellite or cellular signal can be maintained. In addition, different purchasing agents accessing these sites can ascertain historical data.

Another advantage is that the method allows ledger or other data fields to be defined based on the particular needs of a user at a particular time. The ledger fields can be customized and re-customized for subsequent uses (or customizations can be saved for future use).

Yet another advantage is derived from the use of the three-part form used for the tracking and verification of receipt of goods by a supplier of goods. The form, which can be either paper or electronic, enables the receiving agent to dispense with sending a copy to an accounts payable department because the third part of the form, or the electronic version of the form that includes the electronic signature as proof of delivery is already sent or transmitted there by the supplier. Thus, the need for chasing lost form copies indicating verification and receipt of goods and filing additional copies is eliminated.

### BRIEF DESCRIPTION OF THE DRAWINGS

FIG. 1 is a schematic block diagram of an exemplary system for ordering goods utilizing a content-based database that can be accessed through a web site address of the Internet in accordance with the present invention.

FIG. 2 is a schematic block diagram of a procurement process in accordance with the present invention.

FIG. 3 is a schematic block diagram of a need identification step of the procurement process of FIG. 2.

FIG. 4 is a schematic block diagram of a web page access step of the procurement process of FIG. 2.

FIG. 5 is a schematic block diagram of an order placement step of the procurement process of FIG. 2.

FIG. 6 is a schematic block diagram of a receiving step of the procurement process of FIG. 2.

FIG. 7 is a schematic block diagram showing the use of a three-part form for the tracking and verification of the goods in the receiving step of FIG. 6.

### DETAILED DESCRIPTION OF THE PREFERRED EMBODIMENTS

The present invention is directed to a web-based method of procuring goods utilizing order forms customized for use by a particular user. The custom electronic order form can be accessed via a web site address. As used herein, the term “user” is intended to embody an individual company or other organization having or acting as a purchasing agent, buyer, cost analyst, or person whose duties include the procurement of goods. Each user or customer can access an order form that is customized to the user's procurement needs. The form can be customized for the user and to a certain extent by the user. The procurement process can be determined by an inventory of the user's facility, by an audit of the user's procurement records, and/or by querying personnel involved with the procurement needs of a user. Once the procurement needs are determined, a flow chart of the steps involved in the user's procurement process can be developed. Data indicative of the user's procurement habits is then input into a content database. This data can be retrieved and displayed on the customized order form accessible via the web site. The retrieved data can be further manipulated to customize the order form to the user's specific needs. Links can also be provided to other web pages. Such links may utilize the content database to present various other product specifications and information for the benefit of the user, including, but not limited to, such things as detailed product comparisons. Furthermore, new product searches and current procurement data from the customized order form can be accessed from the same web site.

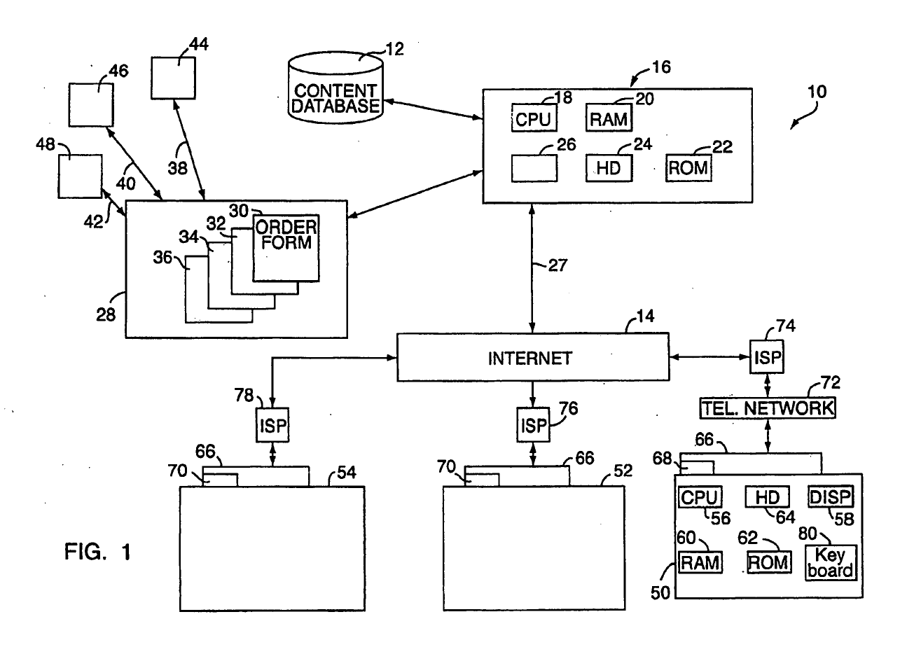

Referring to FIG. 1, an exemplary embodiment of a system for procuring goods is shown generally at 10 and is hereinafter referred to as “system 10.” System 10 utilizes a content database 12 that can be accessed through a computer network. The system 10 includes a server 16 having a server central processing unit (CPU) 18, server memory that can include random access memory (RAM) 20, read only memory (ROM) 22, a hard drive (HD) 24, and an electronic communication apparatus 26 for communicating, as indicated by reference numeral 27, with the computer network. As is used herein, the computer network may be the Internet and is hereinafter referred to as “Internet 14.” As is understood by those of ordinary skill in the art, the Internet 14 is an interconnected network of computers that spans a wide geographical area and can include dedicated transmission lines, satellite communication up-links and down-links, portions of telephone networks, and various gateway and router computers and switching apparatuses. While the computer network has been shown and described as the Internet, the present invention is not limited in this regard. For example, intranets, including those that include locations remote from one another are also contemplated by the present invention.

The content database 12 representative of information indicative of goods and/or services available for display to users is resident on the server as is a web site 28 that includes order forms 30 for user access using a web browser. The term “goods” as used in this electronic application includes, but is not limited to, raw materials, purchase parts, processed materials (e.g., machined or plated parts), assemblies of parts and/or raw materials, and maintenance, repair, and operational (MRO) items such as packaging, janitorial, food service, safety, and maintenance items. The term “services” should be broadly construed to include advertisements, warranties, maintenance contracts and the like.

As will be described in greater detail hereinafter, the order form which may constitute all or part of a web page can be customized to a user's particular procurement needs and habits. This information is stored in the content database, and may be obtained by, for example, inventorying a user's facility, auditing procurement records, querying personnel involved with procurement or tracking and analyzing a user's past procurement habits, or any combination thereof.

The custom electronic order form can display a variety of goods relevant to the user's specific needs or that are related to the user's business. The user can fill in the order form and enter an order for all goods listed on the order form.

The order form which can be in the form of a web page 30 is linked to a plurality of other web pages 32, 34, 36, etc. to present the user access to the content database 12 and various customized venues relevant to the particular user. By way of example, web page 32 can present other product information and specifications of interest to a user, web page 34 can present information relevant to new products searches, and web page 36 can present current user procurement data. Furthermore, the web site 28 provides links for communicating, as indicated by reference numbers 38, 40 and 42, with the other web sites 44, 46, and 48 respectively.

The system 10 can also include a plurality of user computers 50, 52, 54, etc. for providing the information from the web site 28 to the users. Each of the user computers 50, 52, and 54 includes a user computer central processing unit (CPU) 56; a display 58 for communication of the information to users; user computer memory that can include RAM 60, ROM 62, and a hard drive 64; and an electronic communication apparatus 66 for communicating with server computer 16 using the Internet 14. The electronic communication apparatus can include a modem or a local area network (LAN), either of which can access an ISP 74 through a communication line such as a telephone network, television cable lines, satellite links, DSL lines, or the like. Each of the user computers 50, 52, and 54 also include a user-input element 80 that includes one or more of a keyboard, mouse, light pen, or tablet and digitizer, for example. The user computers 50, 52, and 54 will typically be an IBM-type or Apple Personal Computer (or compatible analogs thereof) suitable for running a browser program and accessing the Internet 14.

As noted above, the computers 16, 50, 52, and 54 can include an electronic communication apparatus 26 and 66, respectively. The term “electronic communication apparatus,” as used herein, refers to an apparatus that facilitates electronic communication with another computer using a selected interconnection mechanism, such as a telephone network, a LAN, an intranet, or the Internet, and a selected communication protocol, such as V.90 or V.32, or in the case of the Internet, TCP/IP. The electronic communication apparatus can also include wireless or IR communication mechanisms. Electronic communication apparatus also includes circuitry that provides parallel, serial, Scsi, USB, Firewire, and other such ports known in the art, and protocols such as, but not limited to, Appletalk. The foregoing are merely examples of electronic communication apparatus, and the present invention is not limited to these examples.

The content database 12 resident on the server 16 aids the provision of information indicative of raw material, parts, supplies, and services in the form of a customizable order form to the user computers 50, 52, and 54 for display by the screen 58. The content database 12 can include information stored locally, that is, on the memory of the server 16, and can also include links or pointers to information available elsewhere, such as on other sites (e.g., web sites 44, 46, 48, or the like) on the Internet 14.

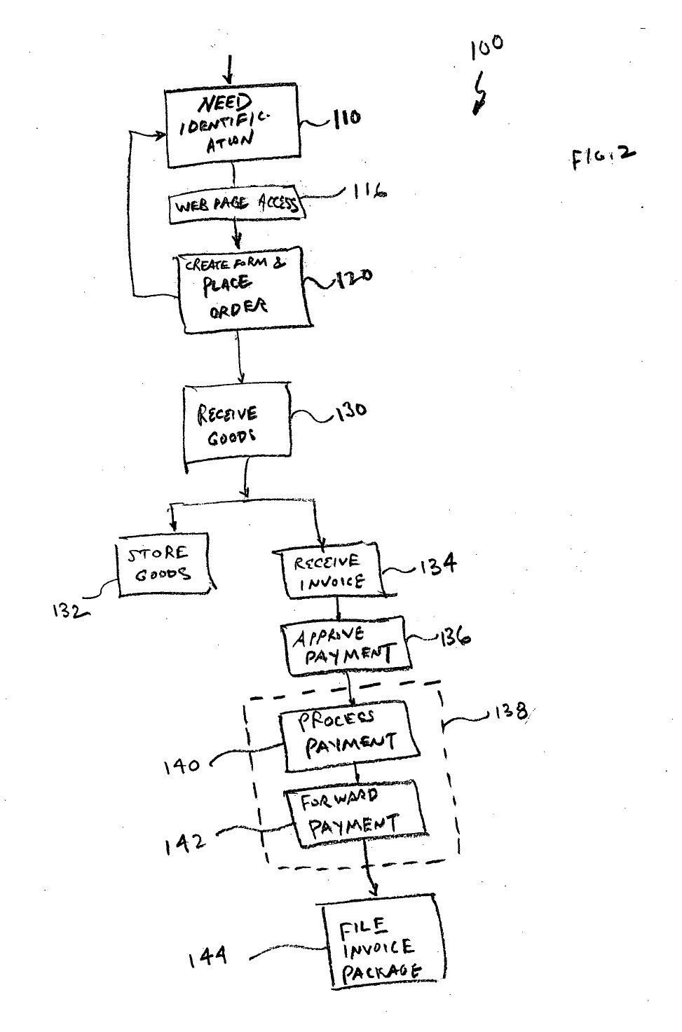

Referring to FIG. 2, an exemplary procurement process is shown generally at 100. In the procurement process 100, the flow of goods to the user is embodied in the identification step 110 in which the need for goods is identified, the web page where the custom electronic order form is located is accessed in a web page access step 116, an order is placed in an order placement step 120 by “filling out” the custom electronic order form, and the ordered items are shipped in a receiving step 130. Once received, the goods are distributed to their final location at a user's facility in a distribution step 132. Upon placing an order, or subsequent to, or simultaneously with shipping, an invoice is received in an invoice receiving step 134, the invoice is approved for payment in an approval step 136, and payment is made in a payment step 138. In the payment step 138, a payment instrument is processed in a processing step 140 and forwarded to the supplier in a forwarding step 142. In the forwarding step, a check (or other form of payment) may be attached to a copy of the invoice and mailed (or otherwise forwarded) to the supplier, a credit card number may be given, or funds may be transmitted electronically to the supplier. Finally, the invoice package containing receipts and copies of the payment form as well as any other pertinent documents is filed in a filing step 144.

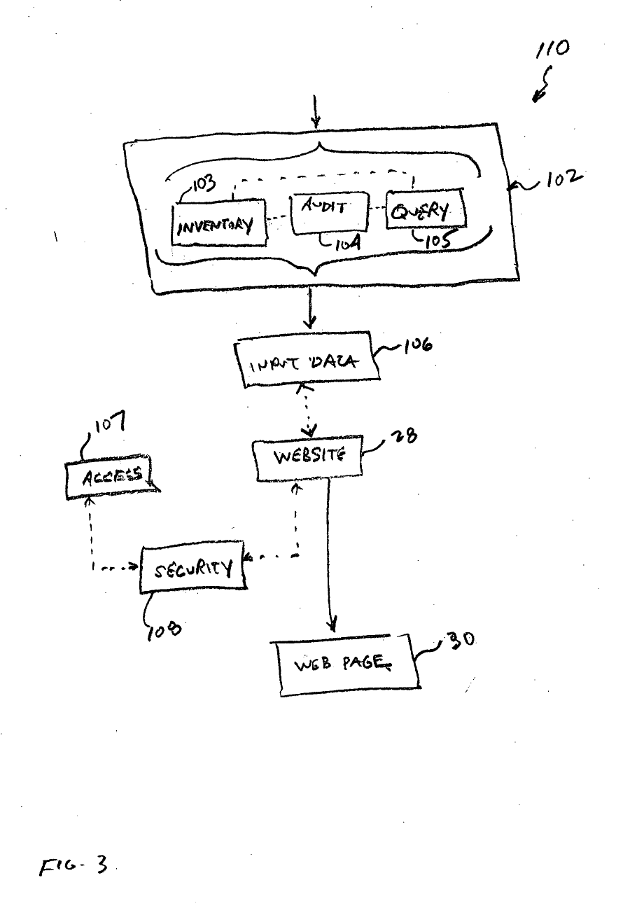

Referring to FIG. 3, one exemplary identification step 110 is shown. The identification step 110 is initiated by a determination step 102 in which product requirements are determined. Typically, the determination of product requirements are effected in at least one of three separate steps, viz., via an inventory step 103, an audit step 104, or a query step 105. This can be conducted by, for example, the user or by a service provider related to the database and the web site 28. Such a service provider may be an organization that sells the use of and/or maintains the database and web site 28. In addition, the query step can be user initiated and may consist of accessing the web site and answering questions online or by simply filling in the order form for the first time. In this manner a user may create their own electronic custom order form.

In any of the three separate steps, parameters relating to the goods on hand are determined. In the inventory step 103, parameters that may be defined include, but are not limited to, the specific number of items. In the audit step 104, an audit of the user's procurement records may reveal information pertaining to frequency of use for specific products, unit costs, supplier information, delivery information, and shipping information. In the query step 105, personnel involved with the procuring of goods are queried to track the actual workflow involved in the purchase of an item. The query step 105 can also include online questionnaires, or the “filling in” of an order form.

After the product requirements are determined from the determination step 102, the data indicative of the user's needs is entered into the database in a data input step 106, the database being in communication with the web site 28. The entered data is subsequently utilized on the customized order form.

Proceeding to an interface step 107, a user interfaces with the web page 32 via the web site 28 by entering the web site address or by using a suitable iconographic item and a point-and-click device (or other means). For example, a user points to and clicks an icon using a mouse (or the like) on the display screen of the computer. One or more security measures may be executed in a security step 108 configured to allow or deny access by the user to the web site 28. Such security measures include, but are not limited to, password procedures, retinal scans, fingerprints, the upload of data (alphanumeric or biometric) from a card having coded information, and the like. Once access to the web site 28 is granted, various messages, greetings, warnings, and/or reminders may be displayed to the user. The process then accordingly continues to a web page access procedure.

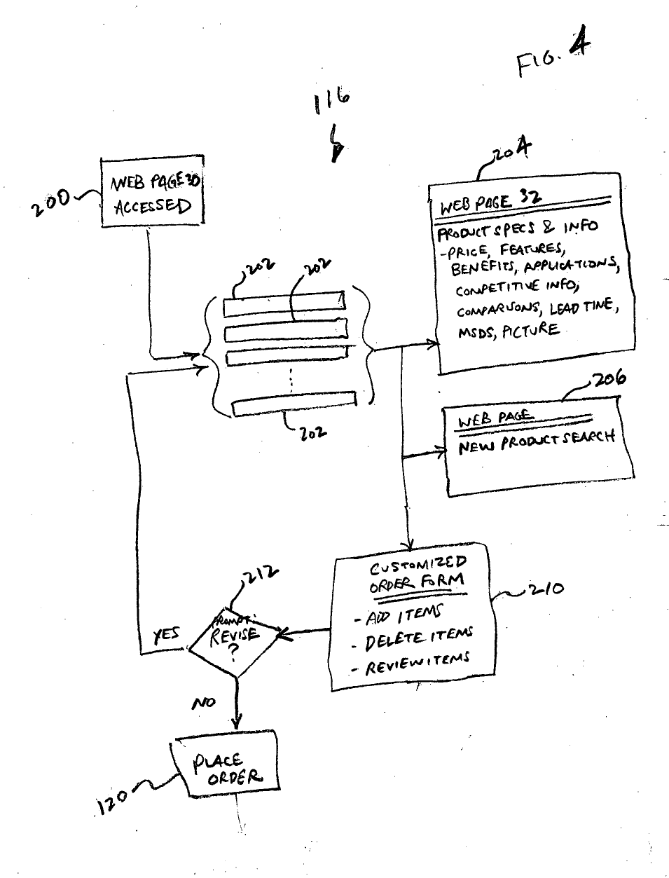

Referring now to FIG. 4, an embodiment of the custom electronic order form access procedure in accordance with the present invention is shown at 116. The custom electronic order form 30 is accessed via a web page and displayed (web page access step 200). The custom electronic order form 30 is tailored to a user's needs and procurement habits based on information obtained in the above-described inventory, audit, query and tracking processes. Once the customized order form is accessed, the user, employing a mouse, pointer, or the like, accesses one or more fields 202 on the order form that are indicative of user defined information pertaining to the goods or other information shown thereon. The fields 202 may be accessed using drop-down menus. The fields 202 on the custom electronic order form 30 can comprise permanent fields that always form part of the order form, and user defined fields. These fields can be customized according to a user's preferences. For example, a user may want to track orders that pertain to a particular department, location or customer. In addition, the user may want to track orders or goods usage pertaining to a particular individual. To accomplish this, the user can be given the option of entering the fields himself or requesting the maintainer of the database to enter the fields. These fields can be entered permanently, for a specified period of time, or for one time use. Alternately, information in the fields 202 may be set to default values.

If information is to be entered into the user defined fields 202 to customize the order form 30, or the summary invoice described in detail below, it may be entered using either a point-and-click device like a mouse or using an alphanumeric device (i.e., a keyboard). In addition, the information can be handwritten onto a tablet, palm device, pocket PC or the like, and then the handwriting can be converted into text. The type of information that may be entered includes, but is not limited to, stock numbers pertaining to the goods, the numbers of units in inventory (or desired to be in inventory), purchase order numbers, shipping instructions, carrier information, names and contact information for various people associated with the procurement process, codes, locations, and the like.

From the website, the user may also access product specifications and information web page 32 where more detailed product specifications and information can be reviewed in any one or a variety of formats, as indicated by specifications access step 204. The information on web page 32 is generated from the database (shown at 12 above) and may include any pertinent information such as, for example, pricing information, features, benefits, application information, competitive information, comparative options, material safety data sheets, quantity discounts, and the like.

The user may also, or alternately, opt to access a web page associated with a new product in a new product search page 206. By doing so, the user conducts a search for new or alternative products. Whether or not a new product has been identified, the program advances to the order form where items can be added, deleted, and/or reviewed in an election step 210. The user is prompted for possible revisions in a revision step 212. By the user's affirmation of the election (declining to make a revision), the program proceeds to the order placement step 120. If, on the other hand, the user elects to revise the order, the user defined fields 202 can be re-accessed.

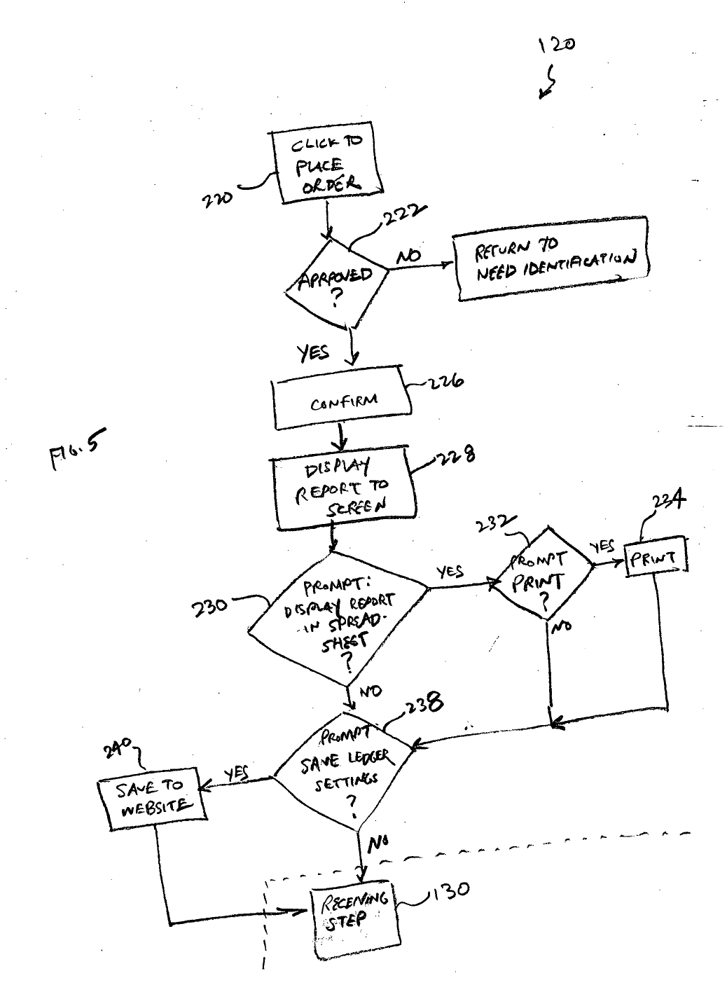

Referring to FIG. 5, once the user elects to place the order, the order placement step 120 is executed. Placing the order is essentially a point-and-click process embodied in a point-and-click step 220 in which data indicative of desired goods is entered into the content database through the network. After the point-and-click step 220, however, the order can be subject to supervisory review and approval in an approval step 222 where it may be rejected. The order may be rejected for any number of reasons, e.g., the user has exceeded a budget limit, the user's company is in arrears, etc. Rejections can also occur automatically due to budget limits being exceeded. These budget limits being set via the user defined fields. These user defined fields can be relevant to, inter alia, the quantity of product that can be ordered at any one time in any single transaction. Accordingly, one of the user defined fields could be a preset quantity budget field. The approval process can be by line items or by user. In addition, password controls can be implemented so that only personnel having approval authority can exercise it. Therefore, authorized personnel can receive an e-mail message that an order is waiting for approval. A link can be “clicked” the person can log in using the password and access the order information for approval. If rejected, the user is directed back to a previous step such as the identification step. If the order is approved, a confirmation step 226 is executed in which a confirmation message with the pertinent details is displayed in a screen report step 228. The message may also display a confirmation number or other data. Messages or data may also be forwarded (e.g., via e-mail or the like) to others associated with the order (salesman, accounting, shipping/receiving, etc.)

Prior to goods being shipped and during the above-described ordering process, a user may be prompted to enter or verify payment information. This may be accomplished by having a user access a pull-down menu with various payment options such as, but not limited to, “on-account,” credit cards, electronic fund transfers and/or internet payment processing services such as PayPal®.

In step 230, the user may be given the option of viewing the confirmation and its associated data in a report. The user may be prompted 232 to print the report in a print step 234. Referring to both FIGS. 4 and 5, the information entered into the fields 202 may be volatile or it may be permanently hard-coded into the database for future uses. The user is prompted 238 via, for example, an automatic pop-up screen that prompts the user to save the settings including any user defined field settings. If the ledger settings are saved in a save step 240, they may be saved to the server computer through the web site. Whether or not the settings are saved for future use, control then passes to the receiving step 130. In addition, once an order is confirmed, information pertaining to what was ordered is saved to the server and used to track inventory, establish preferences, compile statistics, etc.

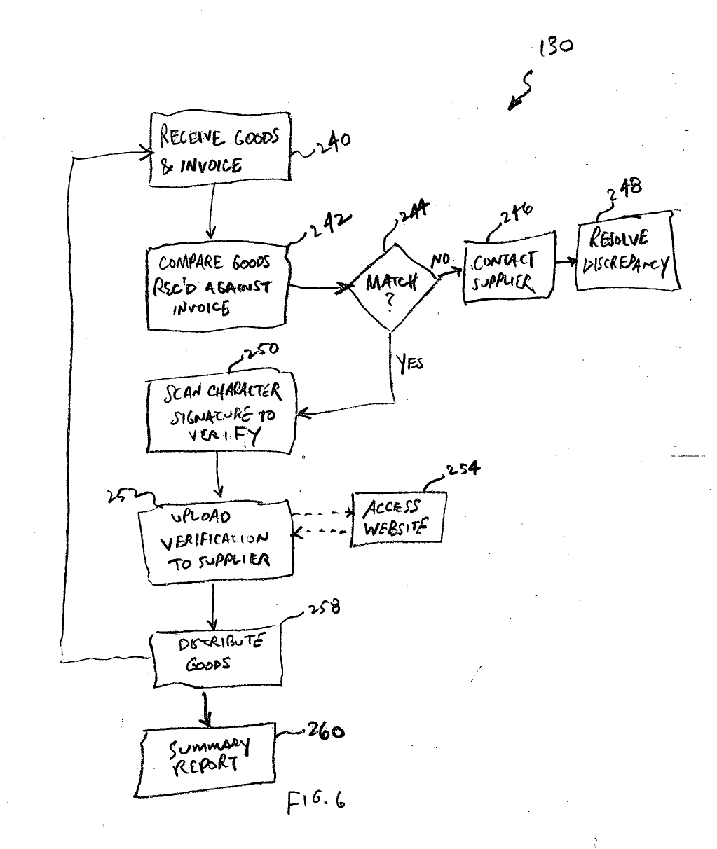

Referring now to FIG. 6, in the receiving step 130, goods have been procured via, for example, the above-described procedure. The goods along with the invoices relevant thereto are shipped to a user-specified location. The goods and the invoice are physically received at this location in a receiving step 240, and the goods may be compared against the invoice in a comparison step 242. The comparison may be made by any suitable method. Suitable methods include, but are not limited to, manually matching items against descriptions or codes on the invoice, scanning barcodes on the items and on the invoice, reading radio frequency identification (RFID) tags on the items and comparing a received signal to codes or RFID data on the invoice, and the like. Where barcodes and/or RFID tags are used, any suitable scanning device such as, but not limited to, handheld scanners or properly equipped cellular phones, can be employed. These devices can either store the scanned information internally and later upload the information to a database, or these devices can directly upload the information to a database. Alternatively, the information can be e-mailed to a designated recipient(s).

If the information pertaining to the received items fails to correspond to the invoices as shown in a matching step 244, the supplier can be contacted 246 and the discrepancy resolved in a resolution step 248. Resolution of the discrepancy may be by return of the entire shipment, receiving of a partial order (subject to verification by the driver or other agent of the supplier), verifying the shipped items manually, or the like. If the information corresponding to the received items and the invoice match, a signature or other information identifying the receiving party is scanned 250 to denote acceptance of the order. The signature may be an electronic signature, a retinal scan, fingerprint scan or other biometric indicia, the upload of data (alphanumeric or biometric) from a card having coded information contained therein, or the like. In any embodiment, the signature may be written, scanned, or uploaded one time and/or repeatedly used to populate several invoices, one or more databases, or be used to provide other notifications that an order was received and by whom. The signature, once scanned, can be programmed to expire (e.g., after a set number of uses, after a period of time, etc.) as a security measure. If the signature is handwritten, the scanning device or the system to which the signature is uploaded, may contain character recognition software that converts a potentially illegible signature into “typed” text. In this manner, both the actual signature and the signature converted into text can be displayed, thereby allowing a person viewing the information to verify the signature and identify the signer.

The goods received may be individual packages, drums, carboys, or individual items packed or stacked on a single or multiple pallets or in one or more shipping containers. However, the present invention is not limited in this regard as the goods can be received in any manner. For example, the goods may be individual unpackaged items, totes of liquid, truck or railcar loads of pourable solids (e.g., gravel, dirt, sand), or tankers of liquid or compressed gas. Such goods, regardless of their form, may require distribution to various and/or remotely located destinations. In such an instance (e.g., when the goods are received at a distribution center), invoices for each final customer may be required. When the number of final invoices is excessive and a receiver in the receiving step 240 is required to sign, for verification purposes, numerous invoices, the electronic signature can be employed thereby allowing the signatory to sign once verifying all invoices. Each invoice is consolidated at the end of a predefined period into a summary invoice.

Once the scanning step 250 is completed, the verification can be uploaded to the supplier in an upload step 252. Typically, the upload step 252 is effected via web access 254, or via upload or storage to a handheld electronic device that can be linked to a portal through which the verification can be uploaded to the supplier or a designated database. Ultimately, a record of the received goods is used in conjunction with the preparation of the above-described web-based custom electronic order forms and/or the above-described summary invoice. The record will be used in tracking the goods ordered and “on-hand” for a customer as well as for establishing a customer's purchasing habits. This manipulated data can be accessed by the particular customer to view usage reports to allow assessment of purchasing needs.

Once the upload step 252 is completed (or simultaneously with the upload step), the goods are distributed in a distribution step 258. The distribution step 258 generally comprises disassembling the package(s) in which the goods are received and physically moving the goods to their respective destinations. From the distribution step 258, the receiving process 130 can be repeated as necessary until all the goods are distributed to their respective destinations. After the receiving process 130 is complete, a summary step 260 may be executed.

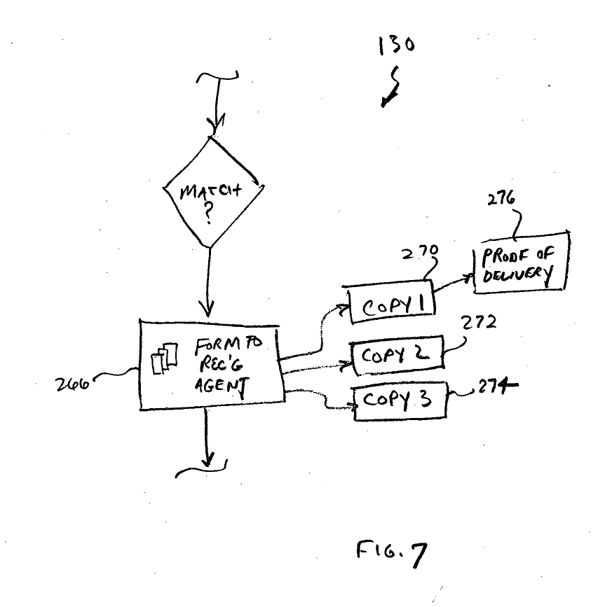

Referring now to FIG. 7, the present invention also contemplates the use of a three-part form or invoice. This invoice can be supplied conventionally in paper form, or the invoice can be electronically generated. When electronically generated, the invoice may also be electronically signed. Each of the three parts of the invoice or form is signed by the receiving agent either manually or electronically in one of the above-described manners. When goods are received, and the three-part form is signed, the different parts of the form are forwarded to their respective destinations. In distributing the form, a first copy is generally left with or forwarded electronically to the receiving agent 270, a second copy remains with or is forwarded to the supplier 272, and a third copy is forwarded to the proper party (e.g., an accounts payable agent) as an invoice 274 for payment. This copy can travel with the goods or be forwarded separately. Once the receiving agent takes the first copy of the form, proof of delivery information is logged onto any electronic data device (e.g., when verification is uploaded in the upload step or in a logging step 276) as verification that goods were received.

Referring now to both FIGS. 6 and 7, when all the goods are distributed or at the option of the supplier, or at the discretion of a customer, the above-described summary invoice may be generated by the supplier in the summary step 260. The summary step 260 may comprise a report in electronic form. Preferably, the report includes indicia that the three-part form was received by the receiving agent in the form distribution step 266. Alternately, the summary step 260 may comprise a report that is accessible from a web site administrated by the supplier upon clicking a link in an e-mailed communication. The summary invoice may contain data fields unique to and/or customized to a particular user's preferences and needs. In addition, the summary invoice can include facsimiles of the actual signatures used to identify the person receiving the goods. These signatures may include a facsimile of the actual handwritten signature along with the signature converted into text. This allows a person receiving the summary invoice to readily verify and authenticate who received particular goods.

In addition to the foregoing, the present invention is also directed to an inventory management system whereby goods can be automatically reordered based on a customer's preferences and designations. In such a system, a user can have their goods stored or warehoused in a particular location. The goods can be coded via bar code, RFID tags, or other scannable devices. Alternatively, the shelves or locations where the goods are stored can be coded. Accordingly, when goods are removed from the shelves, the codes can be electronically scanned using a handheld or stationary device. The device then uploads the information to a server or like device which via software compares the information to customer-determined re-ordering parameters. The software, based on the parameters, then can automatically reorder the particular goods to replenish the supply. The scanner can be used to read the bar code or other identifying information and the quantity removed can be input. Alternatively, each item removed can be scanned. The same procedure can be followed when goods are replenished. Moreover, the scanning device can be positioned, for example, in a doorway so that the goods are automatically scanned as they leave or enter a particular location. In this manner, inventory is automatically controlled and maintained at desired levels.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above-detailed description, but that the invention will include all embodiments falling within the scope of the appended claims.

What is claimed is:

1. A method for procuring goods comprising the steps of:
establishing the need for particular goods and the procurement habits of a customer;
hosting a web site operative with a software-based program and a content database;
inputting data indicative of said customer's needs for particular goods into said content database;
creating a custom electronic order form using said program and said data stored in said content database, said order form being unique to said customer;
said customer accessing said custom electronic order form via a web page on said website;
said customer placing an order for goods by filling in said custom electronic order form;
processing said order;
shipping said goods;
receiving said goods at a customer facility; and
said customer verifying said goods by electronically providing indicia unique to a particular individual.

2. A method as defined by claim 1 wherein said indicia is said individual's handwritten signature created by signing a portion of an electronic tablet.

3. A method as defined by claim 2 wherein said tablet electronically transfers said signature to said content database.

4. A method as defined by claim 2 wherein said tablet is operable to convert said handwritten signature to typed text, thereby making said signature legible, and wherein said tablet stores said handwritten signature and said typed text indicative of said handwritten signature in memory.

5. A method as defined by claim 4 wherein said tablet electronically transfers said handwritten and said typed signature to said content database.

6. A method as defined by claim 1 wherein said indicia is biometric.

7. A method as defined by claim 6 where said indicia is a fingerprint.

8. A method as defined by claim 6 wherein said indicia is a retinal scan of said individual that actually accepts said goods.

9. A method as defined by claim 6 wherein said biometric indicia is electronically transferred to said content database, said software-based program being operable to associate said biometric indicia with said particular individual.

10. A method as defined by claim 1 wherein prior to said step of said customer placing an order, said method includes the further step of providing customer defined fields on said electronic order form, said customer defined fields being populable with user defined information.

11. A method as defined by claim 10 wherein an entity maintaining said content database, at said customer's instruction, enters data into said customer defined fields onto said custom electronic order form prior to said step of said customer placing an order for goods.

12. A method as defined by claim 10 wherein said step of providing customer defined fields includes, said customer accessing said custom electronic order form via said web site and editing said custom electronic order form to include additional customer defined fields.

13. A method as defined by claim 12 wherein said step of editing said custom electronic order form to include said customer defined fields includes accessing a preset menu of data on said web site, and selecting and importing said data into said customer defined fields.

14. A method as defined by claim 10 wherein said method includes the further step of:
generating usage reports based on said customer defined fields and said information populating said customer defined fields.

15. A method as defined by claim 1 comprising the further steps of:
creating a summary invoice indicative of said customer's procurement activities over a period of time; and
said customer electronically accessing said summary invoice.

16. A method as defined by claim 15 further comprising the step of electronically transferring funds to pay said summary invoice.

17. A method as defined by claim 16 wherein said step of electronically transferring funds includes the steps of providing a link on said website to an internet based payment service site and wherein, upon following said link, said customer accesses said internet based payment service and completes an electronic transfer of funds transaction.

18. A method as defined by claim 5 further comprising the steps of:
creating a summary invoice indicative of said customer's procurement activities over a period of time;
associating at least one of said handwritten and converted signatures with said summary invoice;
said customer electronically accessing said summary invoice; and wherein
once accessed, said summary invoice is displayed such that said customer can view said signatures along with said invoiced orders and can associate one with the other as proof of delivery.

19. A method as defined by claim 18 further comprising the steps of:
said customer entering customer defined information into said customer defined fields on one of said custom electronic order form and said summary invoice; and wherein
said step of electronically accessing includes displaying at least a portion of said customer defined information on said summary invoice.

20. A method as defined by claim 1 wherein said step of said customer verifying said goods by electronically providing indicia unique to a particular individual includes scanning said individual's handwritten signature using a scanning device.

21. A method as defined by claim 20 wherein said scanning device is operable to convert said handwritten signature to typed text, thereby making said signature legible.

22. A method as defined by claim 1 wherein subsequent to said step of said customer placing an order for goods by filling in said custom electronic order form, and prior to said step of processing said order, said method includes the further step of causing a person designated by said customer to approve said order.

23. A method as defined by claim 22 wherein said step of causing a person designated by said customer to approve said order further includes said person accessing said web site and entering an indication of approval of said order in a predetermined, designated area of said website.

24. A method as defined by claim 23 wherein said step of causing a person designated by said customer to approve said order further includes said program being configured to e-mail said person designated by said customer and wherein said person indicates said approval or lack thereof by responding to said e-mail.

25. A method as defined by claim 1 further comprising the steps of:
storing said electronic order form in the memory of a processor based system, said order form being operative with said program and said content database, such that the order form lists the goods that meet the historic procurement needs of said customer;
using a security protocol for identifying a user in response to said user accessing said website by providing identification signals thereto unique to said user, said identification signals cooperating with said security protocol;
displaying said electronic order form unique to said user as a web page on said web site in response to said identification signals identifying said user.

26. A method for procuring goods comprising the steps of:
establishing the need for particular goods and the procurement habits of a customer;
hosting a web site operative with a software-based program and a content database;
inputting data indicative of said customer's needs for particular goods into said content database;
creating a custom electronic order form using said program and said data stored in said content database, said order form being unique to said customer;
said customer accessing said customer order form via a web page on said website;
said customer placing an order for goods by filling in said custom electronic order form;
processing said order;
generating an invoice relevant to said order;
shipping said goods;
receiving said goods at a customer facility; and
supplying said customer with said invoice; said invoice containing one part to be forwarded to a receiving party, another part to be forwarded to the supplier of said goods, and another part to be forwarded to the entity responsible for paying for said goods.

27. A method as defined by claim 26 wherein said step of forwarding said invoice to said customer further includes supplying said customer with said invoice at the time of delivery to be signed by a receiver verifying the delivery.

28. A method as defined by claim 26 wherein said step of supplying said customer with said invoice includes:
providing means for allowing said individual to provide an electronic handwritten signature verifying delivery;
said means for allowing said individual to provide an electronic handwritten signature including means for associating said electronic handwritten signature with said invoice; and
electronically forwarding one of said parts of said invoice respectively to each of said receiving party, said supplier and said entity responsible for paying.

29. A method for procuring goods comprising:
establishing the need for particular goods and the procurement habits of a customer;
hosting a web site operative with a software-based program and a content database;
inputting data indicative of said customer's needs for particular goods into said content database;
creating a custom electronic order form using said program and said data stored in said content database, said order form being unique to said customer;
said customer accessing said customer order form via a web page on said website;
said customer placing an order for goods by filling in said custom electronic order form;
processing said order;
shipping said goods;
receiving said goods at a customer facility;
storing said goods;
providing monitoring means for electronically tracking and inventorying said goods.

30. A method as defined by claim 29 wherein said monitoring means includes bar codes printed on at least one of, said goods, said packaging in which said goods are contained, and a particular location where said goods are stored.

31. A method as defined by claim 30 wherein:
said monitoring means further includes a bar code reader; said method comprising the further steps of
scanning said bar code with said bar code reader; and
uploading information indicative of said scanned bar code to said content database.

32. A method as defined by claim 31 further comprising the steps of:
comparing, using said program, said uploaded information with a current inventory of said goods stored in said content database, said program being operable to generate an alert viewable by said customer when said comparing step indicates that said inventory has dropped below a predetermined level.

33. A method as defined by claim 31 further comprising the steps of:
comparing, using said program, said uploaded information with a current inventory of said goods stored in said content database, said program being operable to automatically reorder said goods when said comparing step indicates that said inventory has dropped below a predetermined level.

34. A method as defined by claim 29 wherein said monitoring means includes RFID devices on at least one of, said goods, said packaging in which said goods are contained, and a particular location where said goods are stored.

35. A method as defined by claim 34 wherein:
said monitoring means further includes an RFID device reader; said method comprising the further steps of
scanning said RFID device with said RFID device reader; and
uploading information indicative of said scanned RFID device to said content database.

36. A method as defined by claim 35 further comprising the steps of:
comparing, using said program, said uploaded information with a current inventory of said goods stored in said content database, said program being operable to generate an alert viewable by said customer when said comparing step indicates that said inventory has dropped below a predetermined level.

37. A method as defined by claim 35 further comprising the steps of:
comparing, using said program, said uploaded information with a current inventory of said goods stored in said content database, said program being operable to automatically reorder said goods when said comparing step indicates that said inventory has dropped below a predetermined level.

38. A method for procuring goods comprising the steps of:
hosting a web site operative with a content database;
inputting information indicative of a customer's needs for particular goods or services into said content database;
creating a custom electronic order form, accessible via said web site, using said information stored in said content database and software associated therewith, said custom electronic order form being unique to said customer;
subsequent to the establishment of said custom electronic order form, populating said custom electronic order form, at least temporarily, with one or more customer defined fields, said customer defined fields being populable with customer defined information.

39. A method as defined by claim 38 wherein said method includes the further step of:
generating usage reports based on said customer defined fields.

40. A method as defined by claim 38 wherein said step of populating said custom electronic order form with customer defined fields includes:
causing an entity maintaining said content database to, at said customer's instruction, enter customer defined information into said customer defined fields.

41. A method as defined by claim 38 wherein said step of populating said customer defined fields with said customer defined information includes the steps of:
said customer accessing said web site and editing said customer defined information.

42. A method as defined by claim 41 wherein said step of editing said custom electronic order form to include said customer defined fields includes accessing a preset menu of data on said web site, and selecting and importing said data into said fields.

43. In a client system that includes a display, input means for providing information in response to a user interfacing therewith, a communications device connected to and controlled by a processor, the communications device for connecting the client system to at least one server providing access to at least one web site, a method for ordering goods comprising the steps of:
establishing a connection between said processor forming part of said client system and said server;
accessing a particular website thereby causing the server to download a webpage to the client system from which a user can order a plurality of different goods, the web page being viewable on said display by said user;
customizing an electronic order form operative with said web site, said order form being unique to a particular customer;
using said input means to enter an identification protocol unique to said user, thereby causing said electronic order form to be downloaded form said web site to said connected processor, said electronic order form being viewable on said display;
electronically filling in said electronic order form using said input means, thereby identifying the goods to be purchased;
causing said processor to submit said electronically filled in order form to said server; and
said server accepting electronically generated indicia from a customer verifying acceptance of said goods relevant to said electronically filled in order form.

44. A method as defined by claim 43 wherein said electronically generated indicia is a handwritten signature made by a person authorized by said customer to accept and verify said receipt of said goods, said handwritten signature being stored on said server.

45. A method as defined by claim 44 wherein said server is operable with software to convert said handwritten signature to typed text, said typed text and said handwritten signature corresponding thereto, being stored on said server.

46. In a client system that includes a display, input means for providing information in response to a user interfacing therewith, a communications device connected to and controlled by a processor, the communications device for connecting the client system to at least one server providing access to at least one web site, a method for ordering goods comprising the steps of:
establishing a connection between said processor forming part of said client system and said server;
accessing a particular website thereby causing the server to download a webpage to the client system from which a user can order a plurality of different goods, the web page being viewable on said display by said user;
customizing an electronic order form operative with said web site, said order form being unique to a particular customer;
providing customer defined fields on said electronic order form;
using said input means to enter an identification protocol unique to said user, thereby causing said electronic order form to be downloaded form said web site to said connected processor, said electronic order form being viewable on said display;
electronically filling in said electronic order form using said input means, thereby identifying the goods to be purchased and populating said customer defined fields with customer defined information; and
causing said processor to submit said electronically filled in order form to said server.

47. A method as defined by claim 46 wherein said step of providing customer defined fields on said electronic order form includes:
causing an entity maintaining said server to enter customer defined information into said customer defined fields.

48. A method as defined by claim 46 wherein said step of populating said customer defined fields with customer defined information includes accessing a preset menu of data on said web site, and selecting and importing said data into said customer defined fields.

49. A method for procuring goods comprising the steps of:
establishing the need for particular goods and the procurement habits of a customer;
hosting a web site operative with a software-based program and a content database;
inputting data indicative of said customer's needs for particular goods into said content database;
creating a custom electronic order form using said program and said data stored in said content database, said order form being unique to said customer;
providing customer defined fields on said electronic order form;
said customer accessing said electronic order form via a web page on said website;
said customer placing an order for goods by filling in said custom electronic order form;
processing said order;
shipping said goods;
receiving said goods at a customer facility; and
said customer verifying said goods by electronically providing indicia unique to a particular individual.

50. A method as set forth in U.S. Pat. No. 6,895,389 further comprising the step of a customer verifying receipt of goods by electronically providing indicia unique to a particular individual.

51. A method as set forth in U.S. Pat. No. 6,895,389 further comprising the steps of providing customer defined fields on a custom electronic order form and populating said customer defined fields with customer defined information.
